(19) United States
(12) Patent Application Publication
(10) Pub. No.: US 2017/0048352 A1
(43) Pub. Date: Feb. 16, 2017

(54) COMPUTER-READABLE RECORDING MEDIUM, DISTRIBUTED PROCESSING METHOD, AND DISTRIBUTED PROCESSING DEVICE

(71) Applicant: FUJITSU LIMITED, Kawasaki-shi (JP)

(72) Inventors: Nobutaka Imamura, Yokohama (JP); Toshiaki SAEKI, Kawasaki (JP); Hidekazu TAKAHASHI, Kawasaki (JP); Miho Murata, Kawasaki (JP)

(73) Assignee: FUJITSU LIMITED, Kawasaki-shi (JP)

(21) Appl. No.: 15/220,560

(22) Filed: Jul. 27, 2016

(30) Foreign Application Priority Data
Aug. 10, 2015 (JP) 2015-158537

(51) Int. Cl. H04L 29/08; H04L 12/26; H04L 12/863

(52) U.S. Cl. CPC H04L 67/32; H04L 67/10; H04L 47/62; H04L 43/16

(57) ABSTRACT

Each of slave nodes acquires data distribution information that is data distribution for each portion of processing target data that is subjected to distributed processing performed by each of the plurality of nodes. Then, each of the slave nodes monitors a process state of the distributed processing with respect to divided data obtained by dividing processing target data. Thereafter, each of the slave nodes that performs the monitoring changes, on the basis of the process state of the distributed processing and the data distribution information, the processing order of the divided data that is the processing target.

### CROSS-REFERENCE TO RELATED APPLICATION

This application is based upon and claims the benefit of priority of the prior Japanese Patent Application No. 2015-158537, filed on Aug. 10, 2015, the entire contents of which are incorporated herein by reference.

### FIELD

The embodiments discussed herein are related to a non-transitory computer-readable recording medium, a distributed processing method, and a distributed processing device.

### BACKGROUND

With the popularization of cloud computing, distributed processing systems are used that execute processes on mass data stored in a cloud system by using a plurality of server in a distributed manner. For example, as the distributed processing system, Hadoop (registered trademark) that uses, as the fundamental technology, the Hadoop Distributed File System (HDFS) and MapReduce processes is known.

HDFS is a file system that stores data in a plurality of servers in a distributed manner. MapReduce is a mechanism that performs the distributed processing on data in HDFS in units of tasks and that executes Map processes, Shuffle sort processes, and Reduce processes.

In the distributed processing performed by using MapReduce, tasks related to the Map processes or the Reduce processes are assigned to a plurality of slave nodes and then the processes are performed in each of the slave nodes in a distributed manner. For example, a job tracker of a master node assigns a task of the Map processes to the plurality of slave nodes and a task tracker of each of the slave nodes performs the assigned Map task.

Furthermore, Patitioner performed in each of the slave nodes calculates, in a Map task, a hash value of a key and decides, on the basis of the value obtained by the calculation, a Reduce task that is performed at the distribution destination. In this way, the assignment of Reduce tasks to the slave nodes is equally performed by using a hash function or the like and the process completion time of the slave node with the slowest processing speed corresponds to the completion time of the entire job.

In recent years, as a technology that adjusts Reduce tasks to be assigned to each of the slave nodes, for example, there is a known technology that investigates the number of appearances of a key by sampling input data and that previously assigns Reduce tasks each having different throughput.

Patent Document 1: Japanese Laid-open Patent Publication No. 2014-010500

Patent Document 2: Japanese Laid-open Patent Publication No. 2010-271931

Patent Document 3: Japanese Laid-open Patent Publication No. 2010-244470

However, with the technology described above, even if an amount of data that is finally assigned to each node is equalized, processes become unbalanced at a certain moment, which consequently causes the lengthening of the entirety of the process.

For example, in a MapReduce process, a Reduce task is assigned to each of the slave node in accordance with a key; however, the distribution of appearances of keys sometimes differs depending on a portion of input data. In this case, even if the same amount of data is assigned to each of the slave nodes as a whole, because an amount of data is biased to a specific slave node at a certain moment, the processing load applied to the specific slave node becomes high and the processing speed is decreased. Furthermore, if each of the slave nodes is implemented by a virtual machine, there may be a case in which the processing speed of a virtual machine that performs a Reduce process is decreased because another virtual machine uses the processor resource or a network. Consequently, although the same amount of data is given to each of the slave nodes, the completion time of a process performed in a specific slave node is delayed and the entire completion time of a job is also delayed.

### SUMMARY

According to an aspect of an embodiment, a non-transitory computer-readable recording medium stores therein a distributed processing program that causes a computer to execute a process. The process includes acquiring data distribution information that is data distribution for each portion of processing target data that is subjected to distributed processing performed by a plurality of nodes; monitoring a process state of the distributed processing with respect to divided data obtained by dividing the processing target data; and changing, on the basis of the process state of the distributed processing and the data distribution information, the processing order of the divided data that is the processing target.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating the overall configuration of a distributed processing system according to a first embodiment;

FIG. 2 is a schematic diagram illustrating the mechanism of Hadoop;

FIG. 3 is a schematic diagram illustrating Map processes;

FIG. 4 is a schematic diagram illustrating a Shuffle process;

FIG. 5 is a schematic diagram illustrating Reduce processes;

FIG. 6 is a functional block diagram illustrating the functional configuration of a master node;

FIG. 7 is a schematic diagram illustrating an example of information stored in a job list DB;

FIG. 8 is a schematic diagram illustrating an example of information stored in a task list DB;

FIG. 9 is a schematic diagram illustrating an example of information stored in an estimated result DB;

FIG. 10 is a schematic diagram illustrating an estimating process;

FIG. 11 is a functional block diagram illustrating the functional configuration of a slave node;

FIG. 12 is a schematic diagram illustrating an example of information stored in an assignment settlement table;

FIG. 13 is a schematic diagram illustrating an assignment change;

FIG. 14 is a flowchart illustrating the flow of a process performed by the distributed processing system;

FIG. 15 is a schematic diagram illustrating the lengthening of a process;

FIG. 16 is a schematic diagram illustrating a modification of thresholds; and

FIG. 17 is a block diagram illustrating an example of the hardware configuration of a device.

### DESCRIPTION OF EMBODIMENTS

Preferred embodiments will be explained with reference to accompanying drawings. The present invention is not limited to the embodiments.

### [a] First Embodiment

### Overall Configuration

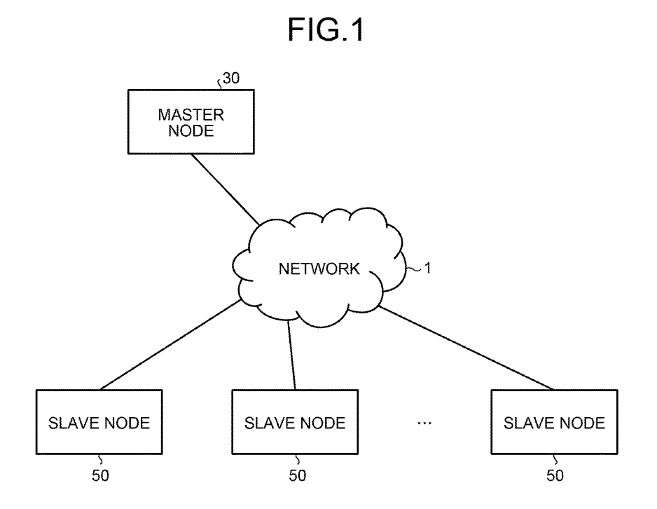

FIG. 1 is a schematic diagram illustrating the overall configuration of a distributed processing system according to a first embodiment. As illustrated in FIG. 1, in this distributed processing system, a master node 30 and a plurality of slave nodes 50 are connected via a network 1 such that they can communicate with each other. In this distributed processing system, a distributed processing application that uses a distributed processing framework, such as Hadoop (registered trademark) or the like, is performed in each server and, furthermore, HDFS or the like is used as data infrastructure.

The master node 30 is a server that performs the overall management of the distributed processing system and functions as a job tracker in a MapReduce process. For example, by using meta information or the like, the master node 30 specifies which data is stored in which of the slave nodes 50. Furthermore, the master node 30 manages tasks or jobs to be assigned to each of the slave nodes 50 and assigns the tasks, such as Map processes or Reduce processes, to the slave nodes 50.

Each of the slave nodes 50 is a server that performs Map processes and Reduce processes and that functions as a data node, a task tracker, a job client, a Mapper, and a Reducer in a MapReduce process. Furthermore, each of the slave nodes 50 performs a Map task assigned by the master node 30, calculates a hash value of a key in the Map task, and decides a Reduce task at the distribution destination by using the value obtained by the calculation. Then, each of the slave nodes 50 performs the Reduce task assigned by the master node 30.

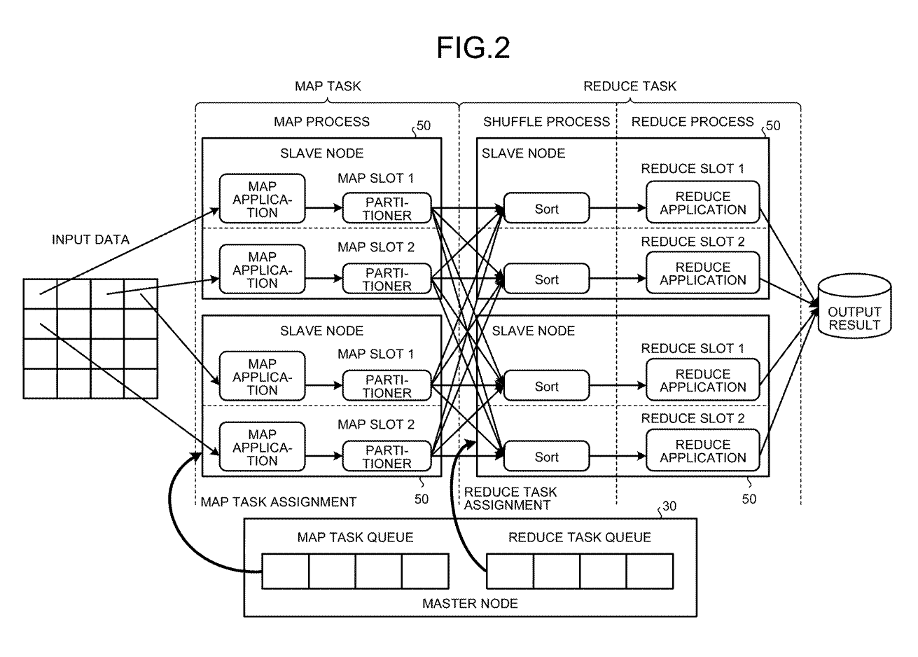

In the following, a Map task and a Reduce task performed by each of the slave nodes 50 will be described. FIG. 2 is a schematic diagram illustrating the mechanism of Hadoop.

As illustrated in FIG. 2, the MapReduce process is constituted by a Map task and a Reduce task; the Map task is constituted by Map processes; and the Reduce task is constituted by Shuffle processes and Reduce processes. The master node 30 includes Map task queues and Reduce task queues and assigns Map tasks and Reduce tasks to the slave nodes 50.

Each of the slave nodes 50 includes at least a single Map slot and a single Reduce slot. Each of the slave nodes 50 performs, in a single Map slot, a Map application and Partitoner. The Map application is an application that executes a process desired by a user and Partitoner decides a Reduce task at the distribution destination on the basis of the result obtained from the execution performed by the Map application.

Furthermore, each of the slave nodes 50 performs a Sort process and a Reduce application in a single Reduce slot. The Sort process acquires, from each of the slave nodes 50, data to be used for the assigned Reduce task; sorts the data; and inputs the sort result to the Reduce application. The Reduce application is an application that executes a process desired by a user. In this way, the output result can be obtained by collecting the results obtained from the execution performed by each of the slave nodes 50.

Here, an example of the Map processes, the Shuffle processes, and the Reduce processes will be described. The processes or input data described here is only an example and is not limited.

Map Process

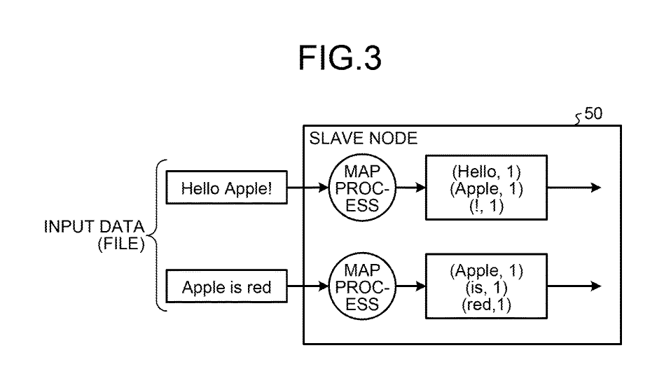

FIG. 3 is a schematic diagram illustrating Map processes. As illustrated in FIG. 3, each of the slave nodes 50 receives, as input data, “Hello Apple!” and “Apple is red”; performs a Map process on the input data; and outputs a “key, Value” pair

In the example illustrated in FIG. 3, the slave node 50 performs the Map process on “Hello Apple!”, counts the number of elements in the input data, and outputs the “key, Value” pair in which the element is indicated by the “key” and the counted result is indicated by the “Value”. Specifically, the slave node 50 creates “Hello, 1”, “Apple, 1”, and “!, 1” from the input data “Hello Apple!”. Similarly, the slave node 50 creates “Apple, 1”, “is, 1”, and “red, 1” from the input data “Apple is red”.

Shuffle Process

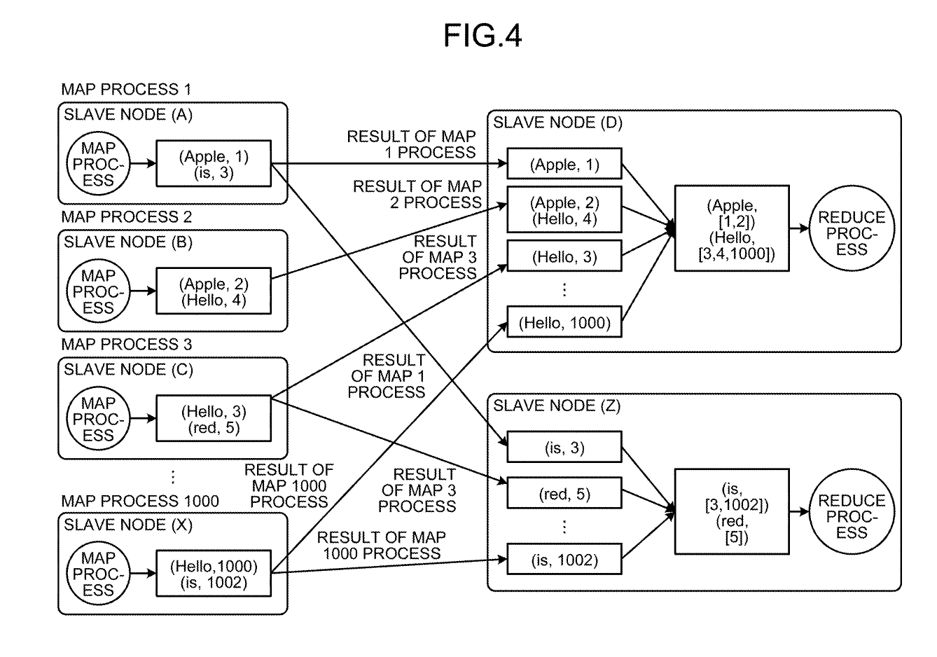

FIG. 4 is a schematic diagram illustrating a Shuffle process. As illustrated in FIG. 4, each of the slave nodes 50 acquires the result of the Map process from each of the slave nodes and performs a Shuffle process.

In the example illustrated in FIG. 4, slave nodes (A), (B), (C), and . . . perform Map tasks belonging to the same job (for example, Job ID is 20) and slave nodes (D) and (Z) perform the Reduce tasks belonging to the Job ID of 20.

For example, the slave node (A) performs a Map process 1 and creates “Apple, 1” and “is, 3”; the slave node (B) performs a Map process 2 and creates “Apple, 2” and “Hello, 4”; and a slave node (C) performs a Map process 3 and creates “Hello, 3” and “red, 5”. The slave node (X) performs a Map process 1000 and creates “Hello, 1000” and “is, 1002”.

Subsequently, the slave node (D) and the slave node (Z) acquire the results, which are used in assigned Reduce tasks, of the Map processes performed by the slave nodes and then sort and merge the results. Specifically, it is assumed that the Reduce tasks for “Apple” and “Hello” are assigned to the slave node (D) and the Reduce tasks for “is” and “red” are assigned to the slave node (Z).

In this case, the slave node (D) acquires, from the slave node (A), “Apple, 1” that is the result of the Map process 1 and acquires, from the slave node (B), “Apple, 2” and “Hello, 4” that are the result of the Map process 2. Furthermore, the slave node (D) acquires, from the slave node (C), “Hello, 3” that is the result of the Map process 3 and acquires, from the slave node (X), “Hello, 1000” that is the result of the Map process 1000. Then, the slave node (D) sorts and merges the results and then creates “Apple, [1, 2]” and “Hello, [3, 4, 1000]”.

Similarly, the slave node (Z) acquires, from the slave node (A), “is, 3” that is the result of the Map process 1; acquires, from the slave node (C), “red, 5” that is the result of the Map process 3; and acquires, from the slave node (X), “is, 1002” that is the result of the Map process 1000. Then, the slave node (Z) sorts and merges the results and then creates “is, [3, 1002]” and “red, [5]”.

Reduce Process

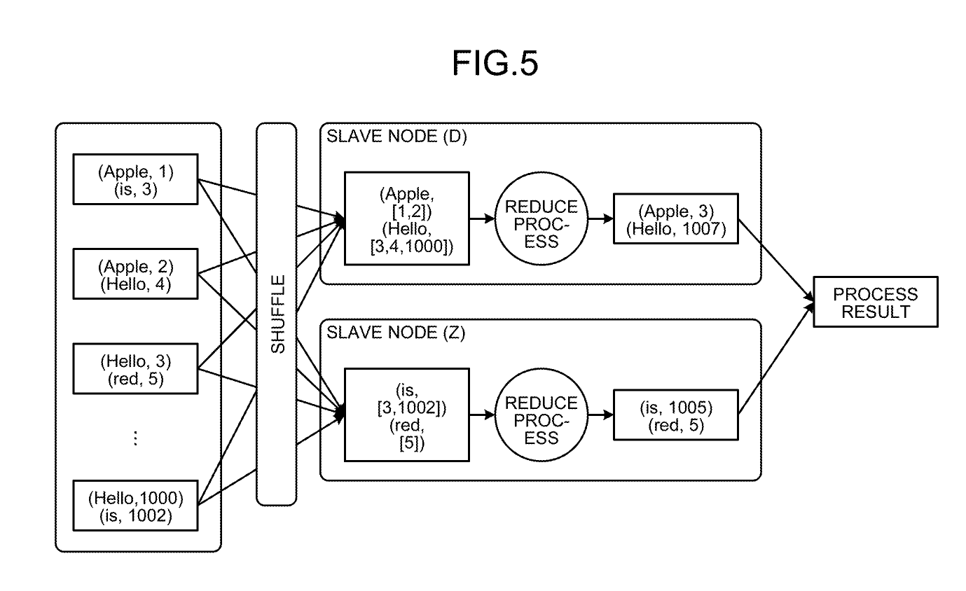

In the following, the Reduce processes performed by the slave nodes 50 will be described. FIG. 5 is a schematic diagram illustrating Reduce processes. As illustrated in FIG. 5, each of the slave nodes 50 uses the Shuffle result created from the results of the Map processes performed by the slave nodes and then performs the Reduce processes. Specifically, similarly to the explanation of the Shuffle process, it is assumed that the Reduce task for “Apple” and “Hello” is assigned to the slave node (D) and it is assumed that the Reduce task for “is” and “red” is assigned to the slave node (Z).

In this example, the slave node (D) adds values from “Apple, [1, 2]” and “Hello, [3, 4, 1000]” that are the result of the Shuffle process and then creates, as the result of the Reduce process, “Apple, 3” and “Hello, 1007”. Similarly, the slave node (Z) adds values from “is, [3, 1002]” and “red, [5]” that are the result of the Shuffle process and then creates, as the result of the Reduce process, “is, 1005” and “red, 5”.

In such a distributed processing system, for a key that is assigned to each of the Reduce processes in the MapReduce process, each of the slave nodes 50 acquires a data distribution state that indicates the number of appearances for each portion of data targeted for the process of the distributed processing that is performed by each of the slave nodes 50. Then, each of the slave nodes 50 monitors an amount of data in each of the buffers that are associated with the respective Reduce processes and that stores therein the processing result of the Map process that is transferred to each of the Reduce processes. Then, each of the slave nodes 50 requests the master node 30 to distribute, to a Map process with priority, the divided data associated with the portion that has a large number of appearances of a key assigned to Reduce that is associated with the buffer with a small amount of data.

Namely, on the basis of the key distribution state for each portion of input data, each of the slave nodes 50 can perform the Map process with priority on the portion that includes many keys handled by the Reduce in which a small load is applied. Consequently, it is possible to eliminate a free Reduce process, equalize the Reduce processes, and suppress the lengthening of the processing time.

Functional Configuration of the Master Node

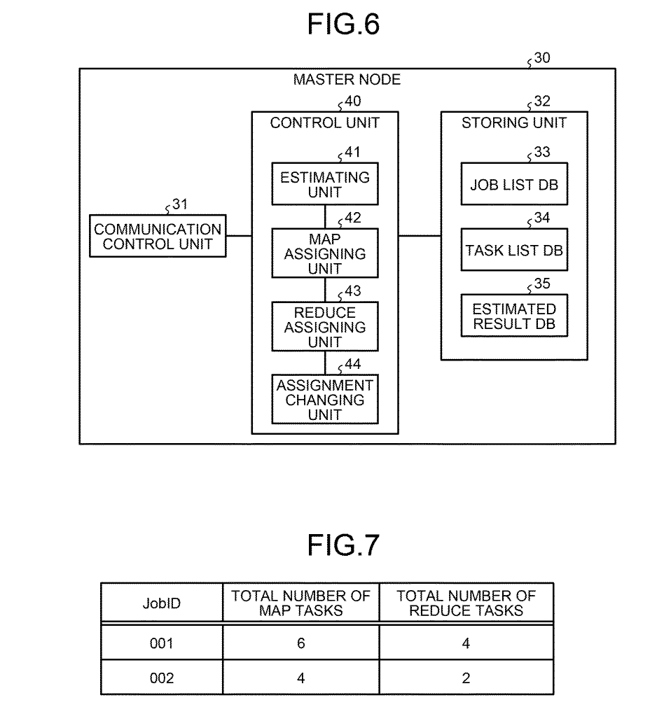

FIG. 6 is a functional block diagram illustrating the functional configuration of a master node. As illustrated in FIG. 6, the master node 30 includes a communication control unit 31, a storing unit 32, and a control unit 40.

The communication control unit 31 is a processing unit that controls communication with each of the slave nodes 50 and is, for example, a network interface card or the like. The communication control unit 31 sends, to each of the slave nodes 50, an assignment state of a Map task or a Reduce task. Furthermore, the communication control unit 31 receives the processing result of the Map task or the Reduce task from each of the slave nodes 50. Furthermore, the communication control unit 31 receives, from each of the slave nodes 50, an assignment change request for the data that is input to the Map task.

The storing unit 32 is a storing unit that stores therein programs or various kinds of data performed by the control unit 40 and is, for example, a hard disk, a memory, or the like. The storing unit 32 stores therein a job list DB 33, a task list DB 34, and an estimated result DB 35. Furthermore, the storing unit 32 stores therein various kinds of general information used in the MapReduce process. Furthermore, the storing unit 32 stores therein input data targeted for a MapReduce process.

The job list DB 33 is a database that stores therein job information on the distributed processing target. FIG. 7 is a schematic diagram illustrating an example of information stored in a job list DB. As illustrated in FIG. 7, the job list DB 33 stores therein, in an associated manner, the “Job ID, the total number of Map tasks, and the total number of Reduce tasks”.

The “Job ID” stored here is an identifier for identifying a job. The “total number of Map tasks” is the total number of Map process tasks included in a job. The “total number of Reduce tasks” is the total number of Reduce process tasks included in a job. Furthermore, the “Job ID, the total number of Map tasks, and the total number of Reduce tasks” are set and updated by an administrator or the like.

The example illustrated in FIG. 7 indicates that the job with the “Job ID” of “Job001” is constituted by six Map process tasks and four Reduce process tasks. Similarly, the example illustrated in FIG. 7 indicates that the job with the “Job ID” of “Job002” is constituted by four Map process tasks and two Reduce process tasks.

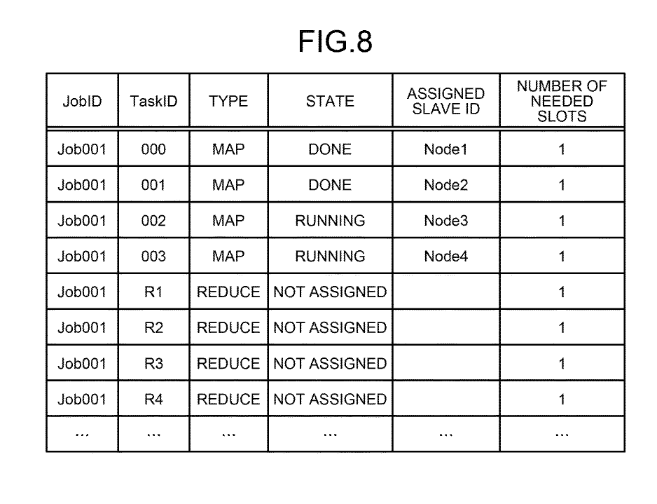

The task list DB 34 is a database that stores therein information related to a Map process task and Reduce process task. FIG. 8 is a schematic diagram illustrating an example of information stored in a task list DB. As illustrated in FIG. 8, the task list DB 34 stores therein the “Job ID, the Task ID, the type, the state, assigned slave ID, the number of needed slots”, or the like.

The “Job ID” stored here is an identifier for identifying a job. The “Task ID” is an identifier for identifying a task. The “type” is information that indicates a Map process and a Reduce process. The “state” indicates one of the states as follows: a process completion (Done) state, an active (Running) state, and a before assignment (Not assigned) state. The “assigned slave ID” is an identifier for identifying a slave node to which a task is assigned and is, for example, a host name, or the like. The “number of needed slots” is the number of slots that are used to perform a task.

In the case illustrated in FIG. 8, a Map process task “Map000” that uses a single slot and that has the job with the “Job ID” of “Job001” is assigned to the slave node 50 with “Node1”. Furthermore, the case illustrated in FIG. 8 indicates that the slave node 50 with “Node1” executes the Map process and indicates that the execution has been completed. Furthermore, the case illustrated in FIG. 8 indicates that a Reduce process task “R2” that uses a single slot that has the job with the “Job ID” of “Job001” is before the assignment performed by Partioner.

Furthermore, the Job ID, the Task ID, and the type are created in accordance with the information stored in the job list DB 33. The slave ID of the slave in which data is present can be specified by meta information or the like. The state is updated in accordance with an assignment state of a task, the processing result obtained from the slave node 50, or the like. The assigned slave ID is updated when the task is assigned. The number of needed slots can previously be specified, for example, a single slot for a task. Furthermore, other than the pieces of information described above, it is also possible to store, on the basis of the execution state of the process, for example, information on a slave node in which data is stored, a processing amount of data of each task, or the like.

The estimated result DB 35 is a database that stores therein, regarding the key that is assigned to each of the Reduce processes in the MapReduce process, the estimated result of the data distribution state that indicates the number of appearances for each portion of the processing target that is subjected to the distributed processing. Namely, the estimated result DB 35 stores therein the estimated result of the number of appearances of a key in each portion in the input data.

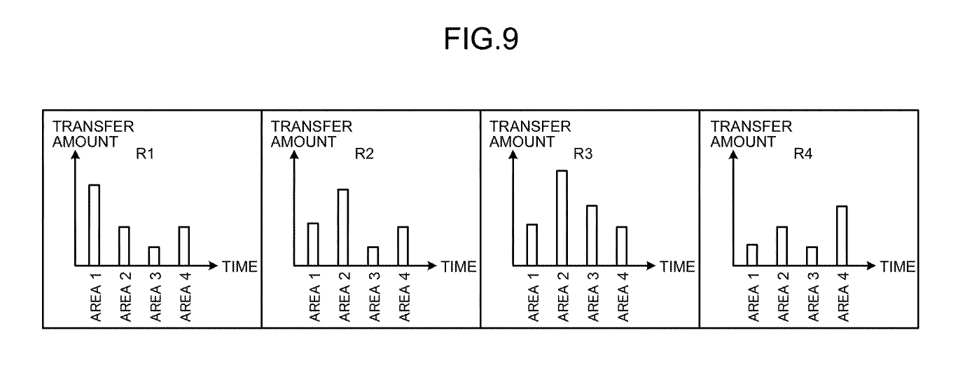

FIG. 9 is a schematic diagram illustrating an example of information stored in an estimated result DB. As illustrated in FIG. 9, the estimated result DB 35 stores therein, for each Reducer, a histogram that indicates the number of appearances of a key in each area for the input data. Namely, the estimated result DB 35 stores, for each Reducer, therein an amount of data transfer that occurs for each area. Furthermore, the Reducer is an example of an application that executes a Reduce task and, here, as an example, a description will be given of an example in which each of the slave nodes corresponds to a single Reducer and a Reducer is associated with a Reduce task. Furthermore, the Reducer is not limited to this and a single Reducer may also execute a plurality of Reduce tasks.

For example, regarding the Reducer that has the “ID of R1” and to which the key “AAA” is assigned, the estimated result DB 35 stores therein the number of appearances in an area 1, the number of appearances in an area 2, the number of appearances in an area 3, and the number of appearances in an area 4 in the input data. Here, an example of storing information by using a histogram has been described; however, the method of storing the information is not limited to this. For example, the information may also be stored as a table format.

The control unit 40 is a processing unit that manages the overall process performed in the master node 30 and includes an estimating unit 41, a Map assigning unit 42, a Reduce assigning unit 43, and an assignment changing unit 44. The control unit 40 is, for example, an electronic circuit, such as a processor or the like. The estimating unit 41, the Map assigning unit 42, the Reduce assigning unit 43, and the assignment changing unit 44 are examples of electronic circuits or examples of processes performed by the control unit 40.

The estimating unit 41 is a processing unit that estimates, regarding the key assigned to each of the Reduce processes in the MapReduce process, a data distribution state that indicates the number of appearances of the key for each portion of the processing target that is subjected to the distributed processing. Specifically, the estimating unit 41 counts the number of appearances of the key for each portion in the input data. Then, by using the number of appearances for each key, the estimating unit 41 estimates an amount of the data transfer generated for each area with respect to each Reducer. Then, the estimating unit 41 stores the estimated result in the estimated result DB 35 and distributes the estimated result to each of the slave nodes 50.

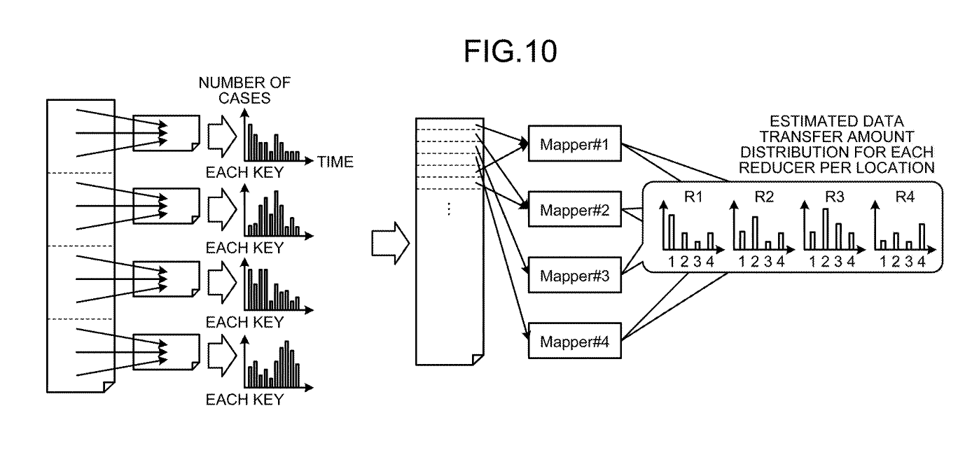

FIG. 10 is a schematic diagram illustrating an estimating process. As illustrated in FIG. 10, regarding each area, the estimating unit 41 divides the input data into four areas and counts the number of appearances of each of the keys, such as a key “AAA”, a key “BBB”, a key “CCC”, . . . , or the like. Then, regarding the Reducer that has the “ID of R1” and to which the key “AAA” is assigned, the estimating unit 41 associates the number of appearances in the area 1, the number of appearances in the area 2, the number of appearances in the area 3, and the number of appearances in the area 4 in the input data. Similarly, regarding the Reducer “R2” to which the key “BBB” is assigned, the Reducer“R3” to which the key “CCC” is assigned, and the Reducer“R4” to which the key “DDD” is assigned, the estimating unit 41 associates the number of appearances of each of the keys in each of the areas in the input data. In this way, the estimating unit 41 estimates an amount of data transfer from each Mapper to each Reducer in an area in the input data.

The Map assigning unit 42 is a processing unit that assigns the Map task, which is the task of the Map process in each job, to a Map slot in the slave node 50. Then, the Map assigning unit 42 updates the “assigned slave ID”, the “state”, or the like illustrated in FIG. 8.

For example, when the Map assigning unit 42 receives an assignment request for a Map task from the slave node 50 or the like, the Map assigning unit 42 refers to the task list DB 34 and specifies the Map task in which the “state” is indicated by “Not assigned”. Subsequently, the Map assigning unit 42 selects a Map task by using an arbitrary method and sets the selected Map task as the Map task targeted for the assignment. Then, the Map assigning unit 42 stores the ID of the slave node 50 that has sent the assignment request in the “assigned slave ID” of the Map task that is targeted for the assignment.

Thereafter, the Map assigning unit 42 notifies the slave node 50 that is specified as the assignment destination of the Task ID of the number of needed slots or the like and then assigns the Map task. Furthermore, the Map assigning unit 42 updates the “state” of the assigned Map task from “Not assigned” to “Running”.

The Reduce assigning unit 43 is a processing unit that assigns a Reduce task to a Reduce slot in the slave node 50. Specifically, the Reduce assigning unit 43 assigns, in accordance with the previously specified assignment rule of the Reduce task or the like, the Reduce tasks to the Reduce slots. In accordance with the assignment, the Reduce assigning unit 43 updates the task list DB 34 as needed. Namely, the Reduce assigning unit 43 associates the Reduce tasks (Reduce IDs) with the slave nodes 50 (Reducers) and performs the assignment by using the main key instead of a hash value.

For example, the Reduce assigning unit 43 assigns the Reduce tasks to the Reduce slot in an ascending order of the Reduce IDs that specify the Reduce tasks. At this point, for example, the Reduce assigning unit 43 may also assign a Reduce task to an arbitrary Reduce slot or may also assign, with priority, a Reduce task to a Reduce slot in which the Map process has been ended. Furthermore, if the Map task is ended by amount equal to or greater than a predetermined value (for example, 80%) with respect to the overall process, the Reduce assigning unit 43 instructs each of the slave nodes 50 to start the process of the Reduce task.

The assignment changing unit 44 is a processing unit that performs, with respect to each of the slave nodes, the assignment of the input data or a change in the assignment of the input data. Namely, the assignment changing unit 44 performs the assignment of the input data with respect to each of the Mappers. For example, the assignment changing unit 44 refers to the task list DB 34 and specifies the slave node 50 in which the Map task is assigned. Then, the assignment changing unit 44 distributes, to each of the specified slave nodes 50, the input data that is the processing target or the storage destination of the input data that is the processing target.

At this point, the assignment changing unit 44 can change the assignment by using an arbitrary method. For example, the assignment changing unit 44 can perform the assignment, regarding the Node1 that is the Mapper#1, in the order of the area 1, the area 2, the area 3, and the area 4 in the input data and can perform the assignment, regarding the Node2 that is the Mapper#2, in the order of the area 3, the area 4, the area 2, and the area 1 in the input data. Furthermore, the assignment changing unit 44 can also give an instruction to process the data in each assigned area by a predetermined amount and can also give an instruction to process the data in an area subsequent to the area after the Map process for the data in the assigned area has been ended.

Furthermore, the assignment changing unit 44 performs, in accordance with the request received from the slave node 50 that is a Mapper, a process of changing the assignment. For example, when the assignment changing unit 44 receives, from the Node1 that is the Mapper#1, an assignment change request including a Reducer#3 (Reduce ID=R3) that is a Reducer with a small data transfer, the assignment changing unit 44 refers to the estimated result of the Reducer#3 (Reduce ID=R3) in the estimated result DB 35. Then, the assignment changing unit 44 specifies that, regarding the Reducer#3 (Reduce ID=R3), a lot of keys are included in the area 2 in the input data.

Consequently, the assignment changing unit 44 changes the assignment such that the data in the area 2 is assigned, with priority, to the Mapper#1 that is the request source. For example, the assignment changing unit 44 can also assign only the data in the area 2 for a certain time period. Furthermore, regarding the assignment ratio of each of the areas, by making the assignment ratio of the area 2 higher than that of the other areas, the assignment changing unit 44 can assign the data in the area 2 to the Mapper#1 by an amount of data greater than that assigned to the other Mappers.

Configuration of the Slave Node

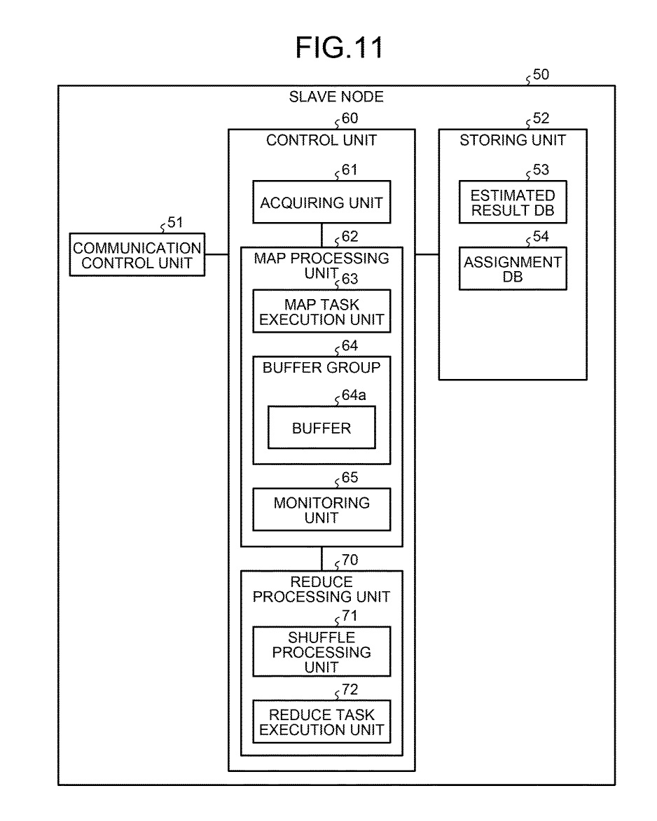

FIG. 11 is a functional block diagram illustrating the functional configuration of a slave node. As illustrated in FIG. 11, the slave node 50 includes a communication control unit 51, a storing unit 52, and a control unit 60.

The communication control unit 51 is a processing unit that performs communication with the master node 30, the other slave nodes 50, or the like and is, for example, a network interface card or the like. For example, the communication control unit 51 receives the assignment of various kinds of tasks from the master node 30 and sends a completion notification of the various kinds of tasks. Furthermore, the communication control unit 51 receives, in accordance with the execution of the various kinds of task processes, divided data that is obtained by dividing the subject input data.

The storing unit 52 is a storing unit that stores therein programs and various kinds of data performed by the control unit 60 and is, for example, a hard disk, a memory, or the like. The storing unit 52 stores therein an estimated result DB 53 and an assignment DB 54. Furthermore, the storing unit 52 temporarily stores therein data when various kinds of processes are performed. Furthermore, the storing unit 52 stores therein an input of the Map process and an output of the Reduce process.

The estimated result DB 53 is a database that stores therein, regarding the key assigned to each of the Reduce processes in the MapReduce process, the estimated result of the data distribution state that indicates the number of appearances of the key for each portion of the processing target that is subjected to the distributed processing. Specifically, the estimated result DB 53 stores therein the estimated result sent from the master node 30.

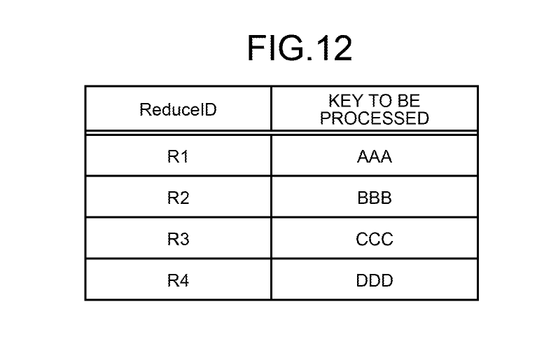

The assignment DB 54 is a database that stores therein the association relationship between the Reduce tasks and the keys. Specifically, the assignment DB 54 stores therein the association relationship between each of the normal Reduce tasks and the key of the processing target and the association relationship between each of the spare Reduce task and the key of the processing target. FIG. 12 is a schematic diagram illustrating an example of information stored in an assignment settlement table. As illustrated in FIG. 12, the assignment DB 54 stores therein, in an associated manner, the “Reduce ID and the key to be processed”.

The “Reduce ID” stored here is information that specifies the Reducer that processes the main key and is assigned to the slave node that performs the Reduce task. The “key to be processed” is the key that is targeted for the Reducer to perform the process and that is targeted for the process in the Reduce task. In the case illustrated in FIG. 12, this indicates that the key targeted for the process performed by the Reducer with the Reduce ID of R1 is “AAA”.

The control unit 60 is a processing unit that manages the overall process performed in the slave node 50 and includes an acquiring unit 61, a Map processing unit 62, and a Reduce processing unit 70. The control unit 60 is, for example, an electronic circuit, such as a processor or the like. The acquiring unit 61, the Map processing unit 62, and the Reduce processing unit 70 are examples of electronic circuits and examples of the processes performed by the control unit 60.

The acquiring unit 61 is a processing unit that acquires various kinds of information from the master node 30. For example, the acquiring unit 61 receives, at the timing at which the MapReduce process is started or at the previously set timing, the estimated result and assignment information sent from the master node 30 by using the push method and stores the estimated result and the assignment information in the estimated result DB 53 and the assignment DB 54, respectively.

The Map processing unit 62 includes a Map task execution unit 63, a buffer group 64, and a monitoring unit 65 and performs, by using these units, a Map task assigned from the master node 30.

The Map task execution unit 63 is a processing unit that executes a Map application that is associated with the process specified by a user. Namely, the Map task execution unit 63 performs a Map task in the typical Map process.

For example, the Map task execution unit 63 requests, by using heartbeats or the like, the master node 30 to assign a Map task. At this point, the Map task execution unit 63 also notifies the number of free slots in the slave node 50. Then, the Map task execution unit 63 receives, from the master node 30, Map assignment information including the Task ID, the number of needed slots, or the like.

Then, in accordance with the received Map assignment information, the Map task execution unit 63 receives data that is targeted for the process from the master node 30 and then performs the subject Map task by using the needed slot. Furthermore, the Map task execution unit 63 stores the result of the Map process in the subject buffer from among a plurality of buffers 64a included in the buffer group 64. For example, when the Map task execution unit 63 executes the Map task with respect to the input data in which the key “AAA” is included, the Map task execution unit 63 stores the processing result of the Map task in the buffer in which the data for the Reducer associated with the key “AAA” is stored.

The buffer group 64 includes buffers 64a for the Reducers to each of which a key is assigned and holds the result of the Map process that is output to the Reducer. Each of the buffers 64a is provided for each of the Reduce IDs of R1, R2, R3, and R4 and data is stored in each of the buffers 64a by the Map task execution unit 63. Furthermore, the data stored in each of the buffers 64a is read by each of the Reducers.

The monitoring unit 65 is a processing unit that monitors the buffer amount stored in each of the buffers 64a in the buffer group 64. Specifically, the monitoring unit 65 periodically monitors the buffer amount of each of the buffers 64a and monitors the bias of the buffer amount. Namely, the monitoring unit 65 detects a buffer with an very large amount of data that exceeds a threshold and detects a buffer with an very small amount of data that falls below the threshold.

For example, the monitoring unit 65 monitors each buffer amount of the buffer with which the Reduce ID=R1 is associated, the buffer with which the Reduce ID=R2 is associated, the buffer with which the Reduce ID=R3 is associated, and the buffer with which the Reduce ID=R4 is associated. Then, when the monitoring unit 65 detects the buffer with the amount of data equal to or greater than the threshold, the monitoring unit 65 specifies the buffer with the smallest buffer amount at that time point and specifies the Reduce ID that is associated with the specified buffer. Thereafter, the monitoring unit 65 sends an assignment change request including the specified Reduce ID to the master node 30.

Furthermore, as another example, the monitoring unit 65 monitors each buffer amount and, when the monitoring unit 65 detects the buffer with the buffer amount less than the threshold, the monitoring unit 65 specifies the Reduce ID that is associated with the detected buffer. Thereafter, the monitoring unit 65 sends the assignment change request including the specified Reduce ID to the master node 30.

In this way, if the monitoring unit 65 detects the Reducer with a small amount of process, i.e., the Reducer that does not currently perform a process, the monitoring unit 65 sends an assignment change request to the master node 30 such that the subject Reducer assigns, with priority, the data that is targeted for the process.

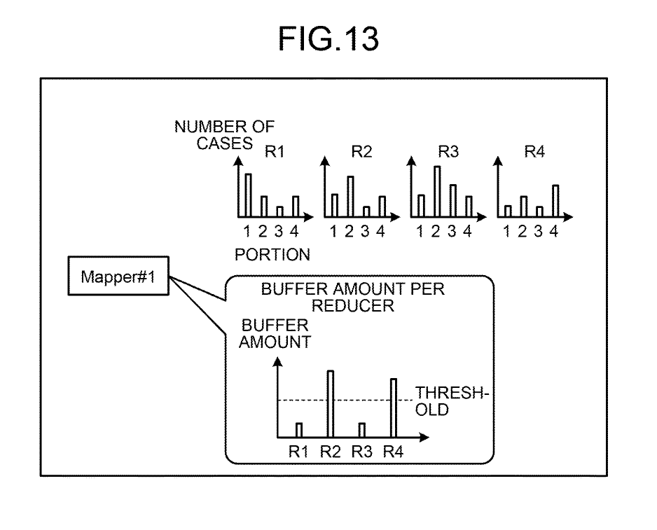

In the following, an example of an assignment change will be described. FIG. 13 is a schematic diagram illustrating an assignment change. As illustrated in FIG. 13, the monitoring unit 65 detects that both the amount of data that is stored in the buffer for the Reducer with the Reduce ID of R1 and the amount of data that is stored in the buffer for the Reducer with the ID of R3 are less than the threshold. Then, the monitoring unit 65 sends, to the master node 30, an assignment change request including the ID of R3 of the Reducer that has a smaller amount of data.

As another example, when the monitoring unit 65 detects the ID indicated by R3 of the Reducer that has a small amount of data, the monitoring unit 65 refers to the estimated result of the ID indicated by R3 in the estimated result DB 53. Then, the monitoring unit 65 specifies, in the estimated result of the ID indicated by R3, that the amount of the data that is processed by the Reducer with the ID of R3 is included in the area 2 is the greatest. Then, the monitoring unit 65 can also send, to the master node 30, a request for the assignment of the data in the area 2 to be increased.

The Reduce processing unit 70 is a processing unit that includes a Shuffle processing unit 71 and a Reduce task execution unit 72 and that executes the Reduce task by using these units. The Reduce processing unit 70 executes a Reduce task assigned from the master node 30.

The Shuffle processing unit 71 is a processing unit that sorts the result of the Map process by a key, that merges the records (data) having the same key, and that creates the target for a process of the Reduce task. Specifically, when the Shuffle processing unit 71 receives a notification from the master node 30 indicating that the Reduce process has been started, the Shuffle processing unit 71 acquires, as a preparation for the execution of the Reduce task of the job to which the subject Map process belongs, the result of the subject Map process from the buffer group 64 in each of the slave nodes 50. Then, the Shuffle processing unit 71 sorts the result of the Map process by using the previously specified key, merges the result of the processes having the same key, and stores the result in the storing unit 52.

For example, the Shuffle processing unit 71 receives, from the master node 30, information indicating that the “Map000, Map001, Map002, and Map003” that are the Map task with the “Job ID” of “Job001” have been ended, i.e., a start of the execution of the Reduce process task with the “Job ID” of “Job001”. Then, the Shuffle processing unit 71 acquires the result of the Map process from the Node1, the Node2, the Node3, the Node 4, and the like. Subsequently, the Shuffle processing unit 71 sorts and merges the result of the Map process and stores the obtained result in the storing unit 52 or the like.

The Reduce task execution unit 72 is a processing unit that executes the Reduce application associated with the process specified by a user. Specifically, the Reduce task execution unit 72 performs the Reduce task assigned by the master node 30.

For example, the Reduce task execution unit 72 receives information on the Reduce task constituted by the “Job ID, the Task ID, the number of needed slots”, and the like. Then, the Reduce task execution unit 72 stores the received information in the storing unit 52 or the like. Thereafter, the Reduce task execution unit 72 acquires the subject data from each of the slave nodes 50, executes the Reduce application, and stores the result thereof in the storing unit 52. Furthermore, the Reduce task execution unit 72 may also send the result of the Reduce task to the master node 30.

Flow of the Process

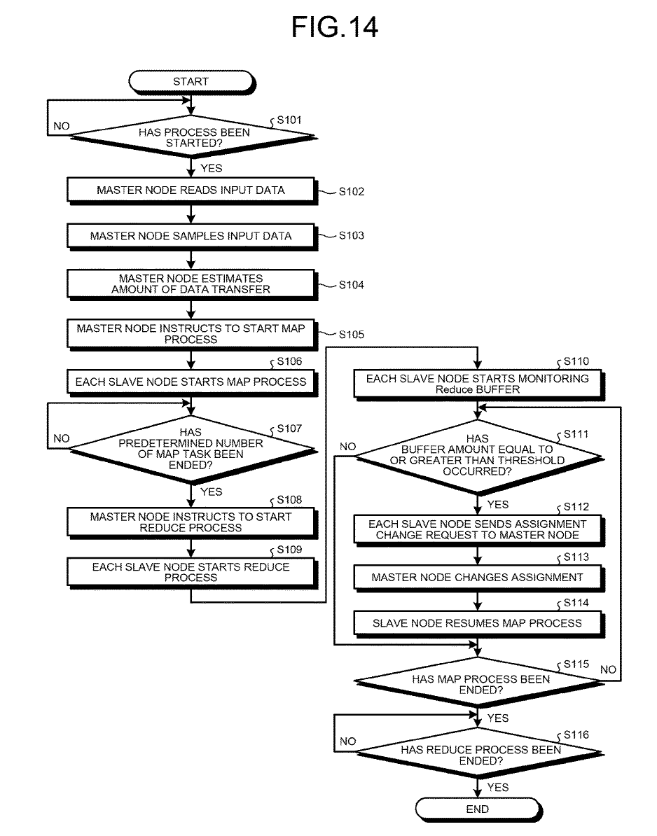

FIG. 14 is a flowchart illustrating the flow of a process performed by the distributed processing system. As illustrated in FIG. 14, if an instruction to start the process is received from an administrator or the like (Yes at Step S101), the estimating unit 41 in the master node 30 reads input data (Step S102). Then, the estimating unit 41 samples the input data (Step S103) and estimates an amount of data transfer to each of the Reducers (Step S104). At this time, the estimating unit 41 stores the estimated result in the estimated result DB 35 and distributes the estimated result to each of the slave nodes 50. Thereafter, the Map assigning unit 42 assigns the Map task to each of the slave nodes 50; the Reduce assigning unit 43 assigns the Reduce task to each of the slave nodes 50; and the Map assigning unit 42 instructs each of the slave nodes 50 to start the Map process (Step S105). Furthermore, the assignment of the Reduce task is not limited to this timing. For example, it is also possible to perform the assignment at the time point at which a predetermined number of Map tasks has been completed.

Subsequently, the Map task execution unit 63 in each of the slave nodes 50 starts the Map process (Step S106). Furthermore, when the Map task execution unit 63 executes the Map task, the Map task execution unit 63 sends the result of the execution to the master node 30.

Then, when the Map tasks the number of which is equal to or greater than a predetermined number have been ended (Yes at Step S107), the Reduce assigning unit 43 in the master node 30 instructs each of the slave nodes 50 to start the Reduce process (Step S108).

Subsequently, the Reduce processing unit 70 in each of the slave nodes 50 starts the Shuffle process and the Reduce process (Step S109). Furthermore, after the Reduce processing unit 70 performs the Reduce task, the Reduce processing unit 70 may also send the result of the execution to the master node 30.

Then, the monitoring unit 65 in each of the slave nodes 50 starts to monitor each of the buffers 64a assigned to the respective Reducers (Step S110). Then, if the monitoring unit 65 detects the buffer amount that is equal to or greater than the threshold in one of the buffers 64a (Yes at Step S111), the monitoring unit 65 sends the assignment change request to the master node 30 (Step S112). For example, while holding the chunk that is currently being processed, the monitoring unit 65 requests, from the master node 30, for the portion in which data for the Reducer that performs a process other than the node in which the buffer amount is equal to or greater than the threshold by using the Reducer name as an argument.

Then, the assignment changing unit 44 in the master node 30 changes the distribution of the input data with respect to the slave node 50 that is the request source (Step S113). For example, the assignment changing unit 44 refers to the histogram stored in the estimated result DB 35 and assigns appropriate data such that the process is started from the area that has a larger amount of data for the notified Reducer. Thereafter, the Map task execution unit 63 in the slave node 50 resumes the Map process with respect to the input data that is newly assigned and that is distributed (Step S114).

Then, until the Map process is ended (No at Step S115), the process at Step S111 and the subsequent processes are repeated. If the Reduce process has been ended (Yes at Step S115), the Reduce process is performed until the Reduce process has been completed (Step S116). Then, if the Reduce process has been completed (Yes at Step S116), the MapReduce process is ended. Furthermore, at Step S111, if the buffer amount equal to or greater than the threshold is not detected in any of the buffers 64a (No at Step S111), the process at Step S115 and the subsequent processes are performed.

Effects

As described above, the distributed processing system according to the first embodiment can detect the Reducer in which a waiting of the input data occurs and can allow, with priority, the portion that includes therein a large number of keys for the subject Reducer to be subjected to the Map process. Consequently, it is possible to reduce the time for which the Reducer waits and equalizes the processes, thus suppressing the lengthening of the processes.

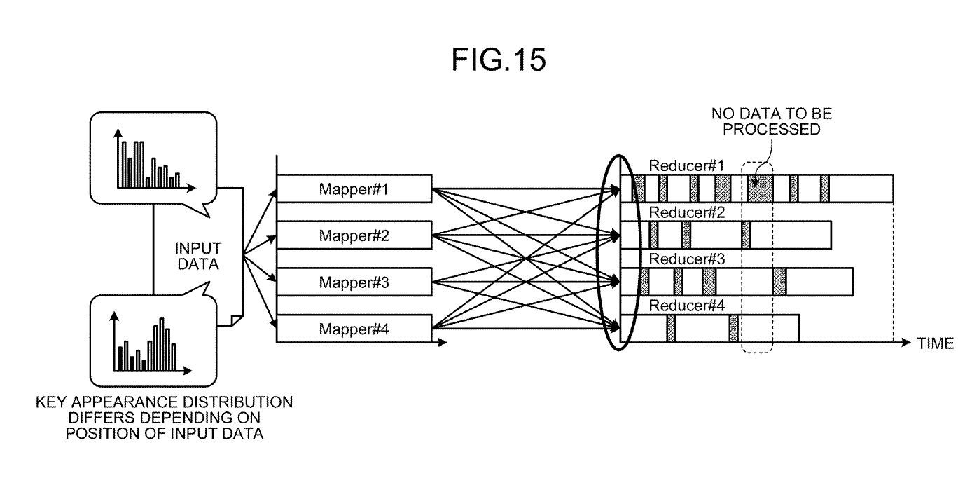

FIG. 15 is a schematic diagram illustrating the lengthening of a process. As illustrated in FIG. 15, the distribution of the keys differs in accordance with the location of the input data. For example, if the MapReduce process that counts the number of words appearing in a plurality of novels written by a certain novelist is performed, the words used in the early novel and the later novels by the subject novelist differ due to a difference of the knowledge of vocabulary or the like.

Thus, even if the assignment of the key to the Reducer is simply equalized by using the number of appearances of the overall keys in the input data, an amount of data to be transferred from the Mapper to the Reducer may possible be biased. For example, the shaded portion illustrated in FIG. 15 indicates the portion with no data to be processed. Furthermore, a processing delay of the Reducer also occurs due to disturbance or the like. For example, if each of the slave nodes is implemented by a virtual machine, there may be a case in which the processing amount that can be performed by a Reduce is decreased due to consumption of processor resources or a network performed by another virtual machine. Furthermore, the load applied to the Reducer may possibly be increased due to the effect of a sudden high load, such as garbage collection in Java (registered trademark).

Consequently, as illustrated in FIG. 15, in the Reducer in which the load is supposed to be equally distributed, the data to be processed is not input and a waiting Reducer is present. In contrast, there may be a Reducer that is not able to acquire data due to a high processing load due to disturbance, the number of appearances of a key, or the lie. In this way, in terms of moment, an amount of data is unequal and, consequently, the lengthening of a process occurs.

In contrast, with the distributed processing system in the first embodiment, the slave node 50 that is the Mapper can monitor the buffer amount of the Reducer and detect the Reducer with a small buffer amount, i.e., the Reducer with a small amount of data to be processed. Then, the slave node 50 can request the master node 30 to distribute, with priority, the input data that has a greater number of keys targeted for the process performed by the Reducer that has a small amount of data to be processed. Consequently, moment to moment, because it is possible to perform the load distribution on the process performed by a Reducer, an amount of data to be processed can be equalized and the lengthening of the processes can be suppressed.

### [b] Second Embodiment

In the above explanation, a description has been given of the embodiment according to the present invention; however, the present invention may also be implemented with various kinds of embodiments other than the embodiment described above. Therefore, another embodiment will be described below.

Setting of a Threshold

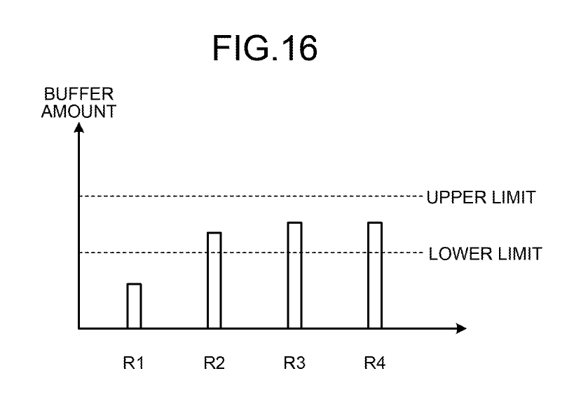

In the embodiment described above, a description has been given with an example in which a single threshold is set as the threshold of a buffer amount; however, the setting of the threshold is not limited to this and a plurality of thresholds may also be set. FIG. 16 is a schematic diagram illustrating a modification of thresholds. As illustrated in FIG. 16, the monitoring unit 65 in the slave node 50 sets an upper limit and a lower limit as the threshold of the buffer amount of each of the buffers 64a.

Then, if the buffer amount that exceeds the upper limit is detected, the monitoring unit 65 sends, to the master node 30, an assignment change request to increase the assignment to a Reducer with the smallest buffer amount at that time. Furthermore, even if the buffer amount that exceeds the upper limit is not detected, if the buffer amount falls below the lower limit is detected, the monitoring unit 65 sends, to the master node 30, an assignment change request to increase the assignment to the Reducer that is associated with the buffer that has the subject buffer amount. Namely, the slave node 50 can also increase the assignment to a Reducer with a small processing amount in order to positively reduce the processing time of the MapReduce, not only a case in which the processing state in a specific Reducer is delayed.

Central Control

In the embodiment described above, a description has been given with an example in which each of the slave nodes 50 monitors a buffer amount; however, the configuration is not limited to this and the master node 30 may also monitor each of the buffer amounts of the slave nodes 50. For example, the master node 30 periodically acquires each of the buffer amounts from each of the slave nodes 50. Then, if the buffer amount that exceeds the threshold, such as the upper limit, the lower limit, or the like, is detected, similarly to the process described above, the master node 30 changes the assignment. In this way, because the master node 30 performs the central control, it is possible to reduce the processing load by monitoring the buffer of each of the slave nodes 50.

Distributed Processing

In the embodiment described above, a description has been given by using a MapReduce process as an example of the distributed processing; however, the distributed processing is not limited to this and various kinds of distributed processing that performs post-processing by using, for example, preprocessing and the result of the preprocessing may also be used.

Input Data

In the embodiment described above, a description has been given with an example in which the master node 30 holds input data and distributes the input data to each of the slave node 50; however, the configuration is not limited to this. For example, each of the slave nodes 50 may also hold the input data in a distributed manner. For example, the master node 30 stores, in an associated manner, “slave ID having data”, in which a host name or the like is set as an identifier for identifying a slave node that holds the data targeted for the Map processing, by further associating the “slave ID having data” with the Job ID of the task list.

Then, the master node 30 notifies each of the slave nodes 50 that are Mappers of the ID (slave ID) of the slave node that holds the data that is targeted for the process. In this way, the slave node 50 acquires data from the subject slave node and executes the Map process. Furthermore, when the master node 30 receives an assignment change request, in order to increase the processing amount, by notifying of the slave ID of the slave node that holds the input data related to the portion that has a large number of the subject keys, the master node 30 can increase the processing amount of the subject Reducer.

System

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise stated.

Furthermore, the components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. Furthermore, all or any part of the processing functions performed by each device can be implemented by a CPU and by programs analyzed and executed by the CPU or implemented as hardware by wired logic.

Hardware

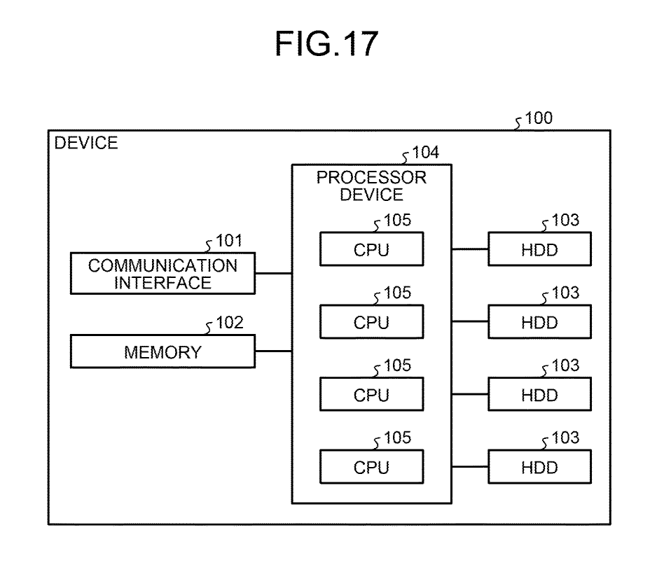

In the following, an example of the hardware configuration of each of the servers will be described. However, each of the servers has the same configuration; therefore, only an example will be described here. FIG. 17 is a block diagram illustrating an example of the hardware configuration of a device. As illustrated in FIG. 17, a device 100 includes a communication interface 101, a memory 102, a plurality of hard disk drives (HDDs) 103, and a processor device 104.

The communication interface 101 corresponds to the communication control unit indicated when each of the functioning units is described and is, for example, a network interface card or the like. The plurality of the HDDs 103 each store therein programs that operates the processing units indicated when each of the functioning units are described, the DB, and the like.

A plurality of Central Processing Units (CPUs) 105 included in the processor device 104 reads, from the HDDs 103 or the like, programs that execute the same processes as that performed by each of the processing units indicated when each of the functioning units has been described above and then loads the programs in the memory 102, thereby the programs operate the processes that execute the functions described with reference to FIGS. 6, 11, and the like. Namely, the processes execute the same functions as those performed by the estimating unit 41, the Map assigning unit 42, the Reduce assigning unit 43, and the assignment changing unit 44 included in the master node 30. Furthermore, the processes execute the same functions as those performed by the acquiring unit 61, the Map processing unit 62, and the Reduce processing unit 70 included in the slave node 50.

In this way, by reading and executing the program, the device 100 operates as an information processing apparatus that executes a distributed processing control method or a task execution method. Furthermore, the device 100 reads the programs described above from a recording medium by using a media reader and executes the read programs described above, thereby implementing the same functions as those performed in the embodiment described above. The programs mentioned in the other embodiment are not limited to be executed by the device 100. For example, the present invention may also be similarly used in a case in which another computer or a server executes the programs or a case in which another computer and a server cooperatively execute the programs with each other.

According to an aspect of the embodiments, it is possible to suppress the lengthening of processing time.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a distributed processing program that causes a computer to execute a process comprising:
acquiring data distribution information that is data distribution for each portion of processing target data that is subjected to distributed processing performed by a plurality of nodes;
monitoring a process state of the distributed processing with respect to divided data obtained by dividing the processing target data; and
changing, on the basis of the process state of the distributed processing and the data distribution information, the processing order of the divided data that is the processing target.

2. The non-transitory computer-readable recording medium according to claim 1, wherein
the acquiring includes acquiring, in the distributed processing that has a first process and a second process that is performed by using the processing result of the first process, a state of the data distribution that indicates, regarding a key that is assigned to each of the second processes, the number of appearances of the key for each portion of the processing target, and
the changing includes requesting each of the nodes that assigns the divided data to assign, with priority, the divided data of the portion with a large number of appearances of the key that has a small processing amount.

3. The non-transitory computer-readable recording medium according to claim 2, wherein
the monitoring includes monitoring an amount of data in each buffer that is used for each of the second processes and that stores therein the processing result of the first process, and
the changing includes requesting each of the nodes to assign, with priority, the divided data of the portion with a large number of appearances of the key that is assigned to the second process in which a buffer amount falls below a threshold.

4. The non-transitory computer-readable recording medium according to claim 2, wherein the changing includes requesting, when bias of the amount of data in each buffer that is used for each of the second process is detected, each of the nodes to assign, with priority, the divided data of the portion with a large number of appearances of the key that is assigned to the second process in which a buffer amount is the smallest.

5. The non-transitory computer-readable recording medium according to claim 1, wherein
the acquiring includes a state of the data distribution that indicates, regarding the key assigned to each Reduce process in a MapReduce process that is the distributed processing, the number of appearances of the key for each portion of the processing target,
the monitoring includes monitoring an amount of data in each buffer that is used for each of the Reduce processes and that stores therein the processing result of the Map process that is transferred to each of the Reduce processes, and
the changing includes requesting each of the nodes that distributes the divided data to assign, to the Map process, the divided data of the portion with a large number of appearances of the key that is assigned to a Reduce associated with a buffer with a small amount of data.

6. A distributed processing method comprising:
acquiring data distribution information that is data distribution for each portion of processing target data that is subjected to distributed processing performed by a plurality of nodes, using a processor;
monitoring a process state of the distributed processing with respect to divided data obtained by dividing the processing target data, using the processor; and
changing, on the basis of the process state of the distributed processing and the data distribution information, the processing order of the divided data that is the processing target, using the processor.

7. A distributed processing device comprising:
a processor that executes a process including:
acquiring data distribution information that is data distribution for each portion of processing target data that is subjected to distributed processing performed by a plurality of nodes;
monitoring a process state of the distributed processing with respect to divided data obtained by dividing the processing target data; and
changing, on the basis of the process state of the distributed processing and the data distribution information, the processing order of the divided data that is the processing target.
